(19) United States
(12) Patent Application Publication
(10) Pub. No.: US 2026/0213685 A1
(43) Pub. Date: Jul. 23, 2026

(54) CHECK OF THE ANISOTROPY OF THE INDUCTANCE OF AN ELECTRIC MOTOR DURING END-OF-LINE COMMISSIONING

(71) Applicant: Schaeffler Technologies AG & Co. KG, Herzogenaurach (DE)

(72) Inventors: Erhard Hodrus, Achern (DE); Christian Eberle, Bühl (DE)

(73) Assignee: Schaeffler Technologies AG & Co. KG, Herzogenaurach (DE)

(21) Appl. No.: 19/141,055

(22) PCT Filed: Nov. 22, 2023
(86) PCT No.: PCT/DE2023/100905

§ 371 Date: Jun. 19, 2025

(30) Foreign Application Priority Data
Dec. 20, 2022 (DE) 10 2022 134 034.1

(51) Int. Cl. H02P 21/18; H02P 21/22

(52) U.S. Cl. CPC H02P 21/18; H02P 21/22

(57) ABSTRACT

A method for verifying the anisotropy of an inductance of an electric motor with an ellipse formed in a d-q plane with a circular excitation in a voltage in the current includes providing an electric machine having a stationary rotor, determining a d-axis, in particular a minor semi-axis, of an ellipse by means of an iterative method and setting an angular offset Gamma_q1, determining a q-axis, in particular a major semi-axis, of an ellipse by means of an iterative method and setting an angular offset Gamma_d1, analyzing the amplitude of the current response of the injected signal in the d-direction and the q-direction, ascertaining a ratio of the current response in the d-direction and the q-direction, and transforming the phase currents in d−45°, d+45°, d+0°and in q−45°, q+45°and q+0°.

### CROSS-REFERENCE TO RELATED APPLICATIONS

This application is the United States National Phase of PCT Appln. No. PCT/DE 2023/100905 filed Nov. 22, 2023, which claims priority to German Application No. DE 102022134034.1 filed Dec. 20, 2022, the entire disclosures of which are incorporated by reference herein.

### TECHNICAL FIELD

The present disclosure relates to a method for determining and/or ascertaining a length difference between a d-axis and a q-axis of an ellipse, in particular for verifying the anisotropy of an inductance of an electric motor during end-of-line commissioning. The disclosure further relates to a device, in particular a control unit, an electric machine and a computer program product.

### BACKGROUND

When an electric motor is operated without sensors, the rotor position sensor, which is usually used to determine the current angle of the rotor, is omitted. Current sensor signals and measured or estimated phase voltages are used to determine the rotor position and speed of the motor via a model.

Below a rotational speed threshold of the absolute rotational speed, it is necessary to feed in so-called injection signals, which support the identification of the rotor position and the speed in this rotational speed range. Starting with a stationary rotor, the rotor position must be determined by an initialization routine.

The initial rotor position can be ascertained by specifying an alternating voltage excitation, a high-frequency oscillation in the d- and q-voltage, for a certain number of points on a voltage circuit path, in which the exciting voltage amplitude leads to a resulting current amplitude. Due to the d-q coordinates, an ellipse in the d-q plane must be formed in the case of a circular excitation in the voltage in the current. In this regard, the main axis of the ellipse corresponds to the d-direction. This direction of the main axis describes the initial value of the rotor position.

It is proposed in the prior art to find the longer main axis of the ellipse, which corresponds to the d-axis, using an iterative controller approach. By applying the injection signal on the voltage, a current can be measured. However, this is not transformed into the notional d-direction here, but into the notional d−45° direction and the notional d+45° direction. This allows for significantly larger amplitudes in the current to be achieved compared to an evaluation of the currents in the d- and q-direction, where the current in the q-direction disappears when the real d-axis is found. This makes detection more robust against disturbances, especially in dynamic situations. The amplitude of the injection signal in the current is then determined using bandpass filtering and the two values for ±45° are compared. The assumed angle is then corrected so that the two amplitudes in the direction +45° and −45° become equally sized. The correction is chosen in such a way that the longer semi-axis is found here, i.e., the d-axis. If the sign is reversed during the correction, the algorithm finds the shorter semi-axis, i.e., the q-axis.

In contrast to buried magnets, the inductances Ld and Lq of bonded magnets are often more similar to one another. The ellipse is then not as pronounced and rather resembles a circle.

The method from the prior art requires different inductances in the d and q directions, as only then the ellipse is pronounced. The ellipse should be reliably recognized even if it is not very pronounced. The aim is to provide a means of ascertaining the ratio of inductances in the system during commissioning from the control unit connected later during operation and thus to evaluate the inductances. This is intended to take into account system-specific influences of the current measurement and the motor parameters.

### SUMMARY

The present disclosure provides a method to determine the initial angle faster and more accurately than the prior art.

The present disclosure provides a method for determining and/or ascertaining a length difference between a d-axis and a q-axis of an ellipse, in particular for verifying the anisotropy of an inductance of an electric motor during end-of-line commissioning.

The ellipse is formed in a d-q plane with a circular excitation in a voltage in the current, and the method includes the following steps:
a) providing an electric machine having a stationary rotor,
b) determining a q-axis, in particular a minor semi-axis, of an ellipse by means of an iterative method and setting an angular offset Gamma_q1,
c) determining a d-axis, in particular a major semi-axis, of an ellipse by means of an iterative method and setting an angular offset Gamma_d1, wherein the d-axis and the q-axis are found by a sign change in the iterative method,
d) analyzing the amplitude of the current response of the injected signal in the d-direction and the q-direction,
e) ascertaining a ratio of the current response in the d-direction and the q-direction, and
f) transforming the phase currents in d−45°, d+45°, d+0° and in q-45°, q+45° and q+0°.

In particular, the method for determining an initial rotor position of a rotor of an electric machine, in particular a synchronous electric machine, includes the following steps:
a) providing an electric machine having a stationary rotor,
b) providing a starting value d_est, which represents a first angle of the rotor position,
c) generating a three-phase alternating voltage excitation in the electric machine by specifying an alternating voltage in a d_est direction,
d) converting the three-phase current response to the alternating voltage excitation of the electric machine for a first modified value d_est−45° into a first alternating current component i_[d_est−45°],
e) converting the three-phase current response to the alternating voltage excitation of the electric machine for a second modified value d_est+45° into a second alternating current component i_[d_est+45°],
f) calculating the length of a first alternating current vector having d and q components for the first alternating current component i_[d_est−45°],
g) calculating the length of a second alternating current vector having d and q components for the second alternating current component i_[d_est+45°], and
h) determining the difference in the absolute values of the lengths between the first alternating current vector and the second alternating current vector according to delta i=|i_d_est+45°|−|i_d_est−45°|,
i) if the condition is met that the difference in the absolute values of the lengths between the first alternating current vector and the second alternating current vector is within a defined interval between 0 and a defined error tolerance value FTW, according to delta_i=i_d_est+45°|−|i_d_est−45°|=[0−FTW], providing the initial rotor angle for energizing the electric machine and terminating the method,
j) if the condition is met that the difference in the absolute values of the lengths between the first alternating current vector and the second alternating current vector delta_i=|i_d_est+45°|−|i_d_est−45°|>0,
k) in the case that |i_d_est+45°|>|i_d_est−45°|, adjusting the starting value d_est in such a way that the angle representing the rotor position is rotated clockwise by a predetermined amount and
l) in the case that |i_d_est+45°|<|i_d_est−45°|, adjusting the starting value d_est in such a way that the angle representing the rotor position is rotated counterclockwise by a predetermined amount,
m) repeating the steps c)-l).

In other words, steps a) and b) of the present disclosure may be carried out by performing the above method. In this way, at least the d-axis can be determined. The determination of the q-axis according to step c) of the claimed method can also be carried out by means of the above method, wherein the sign is reversed accordingly during the correction in order to find/determine the shorter semi-axis, i.e., the q-axis.

In other words, the first step is to find the minor semi-axis of the ellipse. This results in the angular offset Gamma_q1. For this purpose, the above method with steps a) to m) is used with the other sign for the angular correction. The major semi-axis is then found. Here, the angular offset Gamma_d1 is found. This is also the above method with steps a) to m).

Gamma_d1 and Gamma_q1 can differ by substantially ±90°. In other words, the difference between gamma_d1 and gamma_q 1 should be approximately 90° or −90 °, since the assumption is that the d and q axes intersect at right angles.

Once the d and q axes have been found using the algorithm from the method with steps a) to m) using the sign change in the algorithm, the amplitude of the current response of the injected signal is analyzed in the d and q directions. From this, the ratio of the current response in the d and q directions can be ascertained; these values represent inductance data Ld and Lq. If the axis is found, the phase currents must then be transformed not only in d−45° and d+45°, but also in d+0°. The same applies to the q-axis. If the amplitudes of the currents in d and q are too similar, the motor can be filtered out.

Steps b) to f) can be repeated as often as desired. This process can be repeated several times, in particular to ensure that the result is accurate.

A starting value q_est and/or d_est can be selected at random when repeating the method, in particular steps b) to f).

The determined d-axis can be provided as the starting value for determining the q-axis after steps a) and b) have been carried out.

The circular path can be circled at least once in order to find exactly 4 solutions, in particular for the −d- and +d-axis as well as the −q- and +q-axis.

In other words, since the algorithm or method searches for the next angle as a solution at which the two +45° and −45° current amplitudes are the same length, it can make sense to choose the starting values of the notional axes at random for repetitions. However, it is also a good idea to find an axis first and define this as a notional starting value for the next axis. Ideally, the algorithm should circle the circular path once and only find the 4 solutions −q- and +q-axis and −d and +d-axis in this regard.

A demagnetization of the magnets can be concluded from a comparison of the inductances from the end-of-line commissioning. The standardized method for angle initialization is then carried out for operating the motor and the long semi-axis is sought. With this initial value for the angle, the 180° uncertainty is resolved according to the method with the steps a) to m).

Alternatively, the verification can also be carried out during control device start-up each time the vehicle is used. A comparison of the inductances from the end-of-line commissioning can be used to draw conclusions about a demagnetization of the magnets, for example. In principle, weaker magnets are more critical for the unintentional coincidence Ld=Lq, as the pre-saturation of the iron is smaller. A change can, for example, invite a visit to the workshop to replace the parts.

Furthermore, the present disclosure relates to a device, in particular a control unit for controlling and energizing an electric machine, for carrying out the verification method according to any one of the above aspects.

Furthermore, the present disclosure relates to an electric machine, in particular a synchronous electric machine, including a stator and a rotor rotatable relative to the stator and a device for controlling and energizing the electric machine. The device can be designed according to the above aspect.

The present disclosure also relates to a computer program product that is stored on a machine-readable carrier, or a computer data signal embodied by an electromagnetic wave, with program code that is suitable for carrying out the method according to any one of the preceding aspects.

### BRIEF DESCRIPTION OF THE DRAWINGS

The present disclosure is explained in more detail below with reference to figures without limiting the general concept of the invention.

FIG. 1 shows different positions of the d-axis in a d/q coordinate system,

FIG. 2 shows different positions of the q-axis in a d/q coordinate system,

FIG. 3 shows an electric machine in a schematic representation, and

FIG. 4 shows motor vehicles with one hybrid and one fully electrically operable drive train each in a schematic representation.

### DETAILED DESCRIPTION

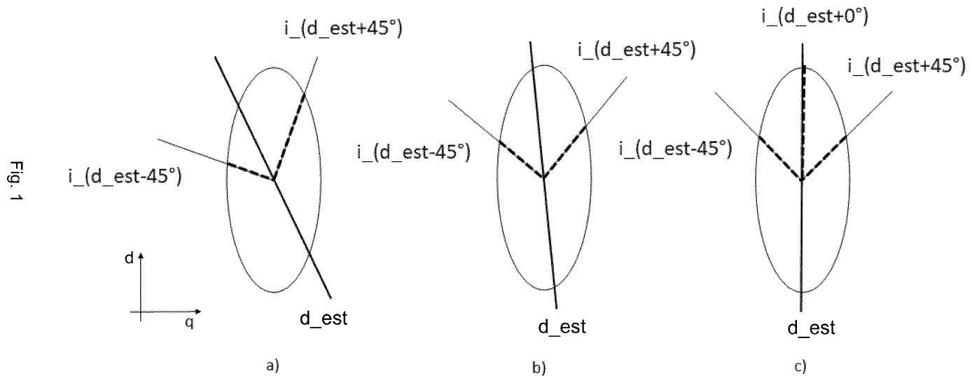

The method for determining an initial rotor position of a rotor 1 of an electric machine 2, in particular a synchronous electric machine, is explained in more detail below with reference to FIG. 1.

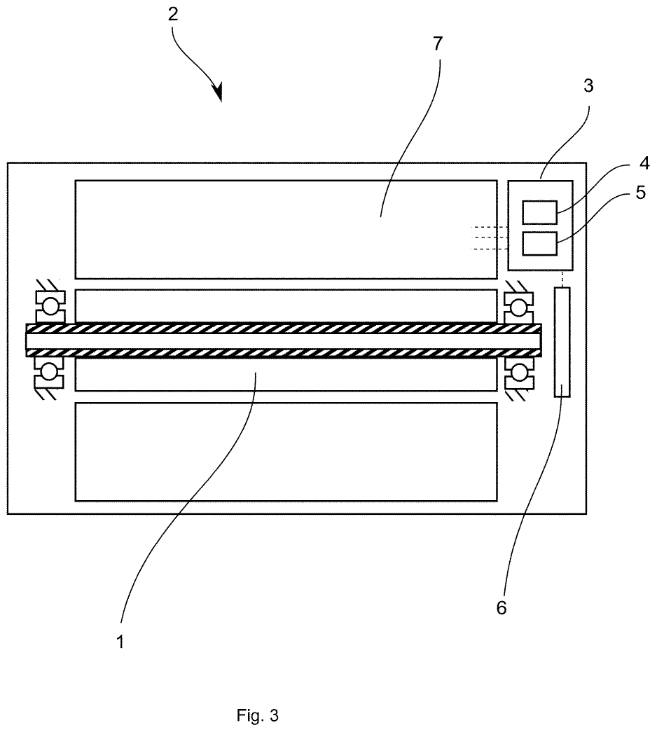

First, an electric machine 2 with a stationary rotor 1 is provided, as shown by way of example in FIG. 3. By means of the control unit 3, in the electric machine 2 a three-phase alternating voltage excitation is then generated in the electric machine 2, which is also indicated in FIG. 3 with the three parallel dashed lines between the control unit 3 and the energized stator 7.

First, a random starting value d_est is provided, which represents a first angle of the rotor position. Based on this starting value d_est, the alternating voltage excitation is applied in the d_est direction. The three-phase current is measured and transformed into the d_est−45° direction, and the modified value d_est−45° is calculated. Analogously, a second modified value d_est+45° is calculated, which corresponds to the starting value d_est plus 45°.

Subsequently, a conversion of the three-phase current response to the alternating voltage excitation of the electric machine 2 is carried out for the first modified value d_est−45°into a first alternating current component i_[d_est−45°], and the conversion of the three-phase current response to the alternating voltage excitation of the electric machine is carried out for the second modified value d_est+45° into a second alternating current component i_[d_est+45°].

These two alternating current components are shown in images a)-c) of FIG. 1. Now the calculation of the length of a first alternating current vector having d- and q-components for the first alternating current component i_[d_est−45°] is carried out, as well as the calculation of the length of a second alternating current vector having d- and q-components for the second alternating current component i_[d_est+45°].

FIG. 1 schematically shows corresponding ellipses in the real d-q plane. The “estimated” d-axis d est is shown and does not coincide with the direction of the d-axis of the d-q plane here. The alternating current components i_(d_est+45°) and i_(d_est−45°) are plotted to match the estimated direction of the d-axis.

Then the difference in the absolute values of the lengths between the first alternating current vector and the second alternating current vector is determined according to delta_i=|i_d_est+45°|−|i_d_est−45°|.

If the condition is met that the difference in the absolute values of the lengths between the first alternating current vector and the second alternating current vector delta i=|i_d_est+45°|−|i_d_est−45°|>0, which can be seen in images a) and b) of FIG. 1, a distinction is made between two further alternatives.

For the first case in which |i_d_est+45°|>|i_d_est−45°|, the starting value d_est is adjusted in such a way that the angle representing the rotor position is rotated clockwise by a predetermined amount, which is shown in images a) and b).

From images a) and b) in FIG. 1 it is clearly visible that the lengths of the alternating current components are different. Therefore, the “estimated” d-axis (d_est) must be rotated clockwise a short way. This new “estimated” d-direction is then the new starting value for the next iteration. One of the next iterations is shown in image b) of FIG. 1.

For the second case in which |i_d_est+45°|<|i_d_est−45°|, an adjustment of the starting value d_est is made in such a way that the angle representing the rotor position is rotated counterclockwise by a predetermined amount, which is not shown in FIG. 1, however.

These iterations are carried out until the condition is met that the difference in the absolute values of the lengths between the first alternating current vector and the second alternating current vector is within a defined interval between 0 and a defined error tolerance value FTW, according to delta_i=|i_d_est+45°|−|i_d_est−45°|=[0−FTW].

In other words, the process is repeated until the projections of the alternating current components and thus the lengths of the absolute values of the alternating current components are equal. The initial angle of the rotor position can then be easily ascertained from the angle of the “estimated” d-axis. This can be seen in image c) of FIG. 1. Then, on this basis, the initial rotor angle is provided to energize the electric machine and the method is terminated.

After this initial angle determination, the d-axis is known and the electric machine 2 can be rotated in the desired rotational direction. This can prevent the electric machine from rotating in the wrong direction, even for a short time, during motor operation. A possible “180° error” must—as with the method known from the prior art—still be ascertained and eliminated using a suitable standard method.

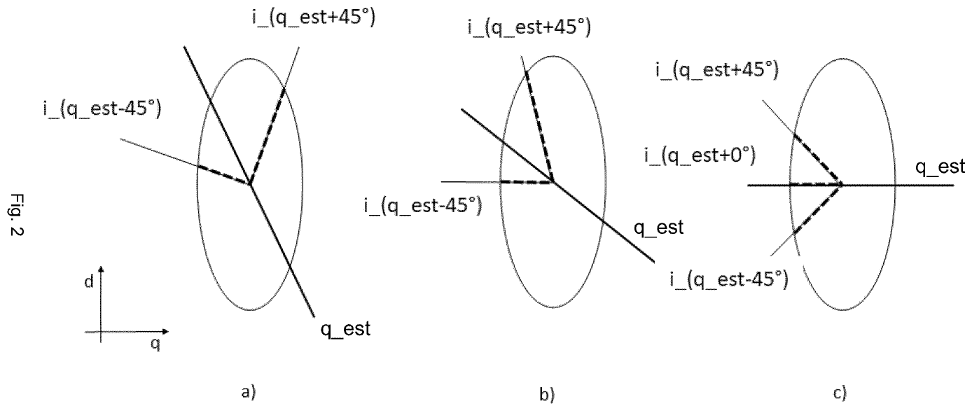

FIG. 2 corresponds almost exactly to FIG. 1, wherein the short semi-axis of the ellipse, i.e., the semi-axis in the q-direction, is sought here. Accordingly, no further description is provided here, as the above description can be read with regard to FIG. 2, with the exception that the “d” must be replaced by a “q”.

As shown in FIG. 3, the control unit 3 for controlling and energizing the electric machine 2 includes a processor 4 and a memory 5 containing a computer program code. The memory 5 and the computer program code are configured, with the processor 4, to cause the control unit 3 to carry out the above method.

Unlike what is shown in FIG. 3, the control unit 3 may not have a connection for a rotor position sensor 6 for detecting the rotor position of the rotor 1, and can be controlled without a sensor. The electric machine 2 shown in FIG. 3 has a stator 7 that can be energized and a rotor 1 that can be rotated relative to the stator 7, as well as the control unit 3 for controlling and energizing the electric machine 2 or the stator 7.

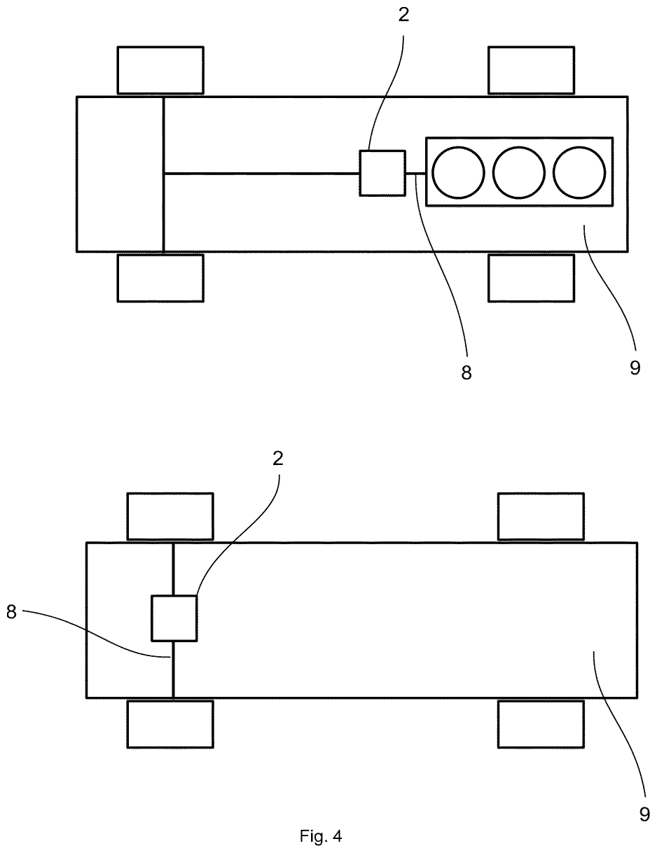

In particular, the electric machine 2 may be used in a hybrid or fully electrically operable drive train 8 of a motor vehicle 9, as also outlined in FIG. 4.

The present disclosure is not limited to the embodiments shown in the figures. The above description is therefore not to be regarded as limiting, but rather as illustrative. The following claims are to be understood as meaning that a stated feature is present in at least one embodiment of the present disclosure. This does not exclude the presence of further features. Where the claims and the above description define “first” and “second” features, this designation serves to distinguish between two features of the same type without defining an order of precedence.

### REFERENCE NUMERALS

1 Rotor
2 Electric machine
3 Control unit
4 Processor
5 Memory
6 Rotor position sensor
7 Stator
8 Drive train
9 Motor vehicle

1. A method for verifying an anisotropy of an inductance of an electric motor during end-of-line commissioning, comprising:
a) providing an electric machine having a stationary rotor,
b) determining a d-axis, in particular a minor semi-axis, of an ellipse by means of an iterative method and setting an angular offset Gamma_q1,
c) determining a q-axis, in particular a major semi-axis, of the ellipse by means of an iterative method and setting an angular offset Gamma_d1, wherein the d-axis and the q-axis are found by a sign change in the iterative method,
d) analyzing the amplitude of the current response of the injected signal in the d-direction and the q-direction,
e) ascertaining a ratio of the current response in the d-direction and the q-direction, and
f) transforming the phase currents in d−45°, d+45°, d+0° and in q−45°, q+45° and q+0°, wherein the ellipse is formed in a d-q plane with a circular excitation in a voltage in the current.

2. The verification method according to claim 1, wherein gamma_d1 and gamma_q1 differ by substantially ±90°.

3. The verification method according to claim 1, further comprising repeating steps b) to f).

4. The verification method according to claim 3 , wherein a starting value q_est and/or d_est is selected at random when repeating steps b) to f).

5. The verification method according to claim 1, wherein, after carrying out steps a) and b), the determined d-axis is provided as a starting value for determining the q-axis.

6. The verification method according to claim 1, wherein a circular path is circled at least once in order to find solutions for the −d- and +d-axis as well as the −q- and +q-axis.

7. The verification method according to claim 1, further comprising determining a demagnetization of the magnets from a comparison of the inductances from the end-of-line commissioning.

8. A control unit for controlling and energizing an electric machine, for carrying out the verification method according to claim 1.

9. A synchronous electric machine, comprising a stator, a rotor rotatable relative to the stator, and the control unit for controlling and energizing the electric machine of claim 8.

10. A computer program product stored on a machine-readable medium, or a computer data signal made manifest by an electromagnetic wave, with program code suitable for carrying out the method of claim 1.
